(19) United States
(12) Patent Application Publication
(10) Pub. No.: US 2010/0206934 A1
(43) Pub. Date: Aug. 19, 2010

(54) FASTENING TOOL FOR FASTENING DIFFERENT LENGTH ELEMENTS

(75) Inventors: Emmanuel Vallon, Portes Les Valence (FR); Patrick Herelier, Saint Jean De Muzols (FR)

Correspondence Address: LOWE, HAUPTMAN, HAM & BERNER, LLP (ITW), 1700 DIAGONAL ROAD, SUITE 300, ALEXANDRIA, VA, 22314, US

(73) Assignee: SOCIETE DE PROSPECTION ET D'INVENTIONS TECHNIQUES SPIT, Bourg Les Valence (FR)

(21) Appl. No.: 12/676,233

(22) PCT Filed: Sep. 3, 2008
(86) PCT No.: PCT/IB08/02287

§ 371 Date: Mar. 3, 2010

(30) Foreign Application Priority Data
Sep. 5, 2007 (FR) 0706213

(51) Int. Cl. B25C 1/18

(52) U.S. Cl. 227/109

(57) ABSTRACT

The tool comprises an assembly of a tip-guide and a shear unit, on which can be fastened a charger of fastening elements. The fastening elements are introduced in the bore of the tip-guide through a passing window provided in the shear unit. The tool comprises a pivoting flap for adjusting the effective length of the passing window to the length of the fastening elements to be driven. The flap is pivotally mounted about an axis substantially parallel to the tip-guide bore and is adapted to provide a guiding surface for the shortest fastening elements before they enter the partially plugged passing window. With the invention, the short elements can neither rock the tool nor jam it.

The invention relates to indirect shooting fastening device for driving a fastening element into a receiving material through a feeder also driven in a tool barrel and then a tip-guide forming the tool nose. The feeder driving energy may be any energy, but generally it is the combustion energy of a powder charge or an air-gas mixture of a cartridge located in the tool.

As examples of fastening elements, staples, nails, or other fastening tips may be mentioned.

The fastening elements are generally introduced into the tool tip-guide bore from a charger removably fixed at the tool nose and at the shear unit, also fastened in turn on the tool, the tip-guide bore being partly formed by the shear unit.

A “shear unit” is mentioned because generally the fastening elements are arranged in strip, being stuck next to each other on a paper or plastic film, which is precisely sheared, at each shot, by the feeder when it drives with it the fastening element located in the tip-guide bore.

The introduction of the fastening elements into the tip-guide bore, from the charger, is done through a passing window provided in the shear unit, the axial length of which is slightly bigger than the length of the longest elements, that the tool is intended to use.

When the feeder, further to the ignition, hits the fastening element located inside the tip-guide, this element tends to hit the tip-guide bore wall and to bounce off it towards the passing window. If they are long fastening elements, the element placed inside the tip-guide then hits the following strip element placed on the other side of the passing window and bounces off it to be appropriately returned inside the tip-guide bore. But, when they are short fastening elements, the element being hit by the feeder can perfectly rock inside the charger through the window and cause a tool jam.

To avoid this risk, the document U.S. Pat. No. 6,808,101 proposes to provide, in the tip-guide and shear unit assembly, a device for adjusting the effective length of the passing window to the length of the charger fastening elements.

This adjustment device is a lever pivotally mounted around a transverse axis, orthogonal to the plan of the charger fastening element strip, that is about a transverse axis and orthogonal to the fastening elements themselves. As a circle shaped sector, it is returned by a spring into a partial plugging position of the passing window to only leave free the portion necessary for the passage of the short fastening elements.

When the charger comprises long fastening elements, against the action of the return spring, they rotate the lever towards the tool nose end to release the whole passing window.

Because of the adjustment lever operation and shape, there is possibly a risk for the short fastening elements to rock onto the other side of the passing window, inside the charger, above the adjustment lever, and jam the charger and the tool.

So the invention according to the present application aims at cancelling any jam risk.

Thus, it relates to a fastening tool for driving fastening elements of different lengths, comprising a tip-guide and shear unit assembly, to which can be fastened a charger comprising fastening elements, the fastening elements being introduced from the charger inside the tip-guide bore through a passing window provided inside the shear unit, the tool comprising a pivoting device for adjusting the effective length of the passing window to the length of the fastening elements to be driven, and which is submitted to return means back to a partial plugging position of the window for the shortest elements, characterised in that the adjustment device comprises a flap pivotally mounted about an axis being substantially parallel to the tip-guide bore and is adapted to provide a guiding surface to the shortest fastening elements before they enter into the partially plugged passing window.

It is through the pivoting action around an axis parallel to the tip-guide bore, more precisely parallel to its axis, that the adjustment flap of the invention tool has been able to be adapted to show this guiding surface for the short elements and, consequently, for their end turned to the tool nose end, and thus avoid their rocking action and therefore a tool jam.

The invention will be further understood from the following description, with reference to the accompanying drawing, in which:

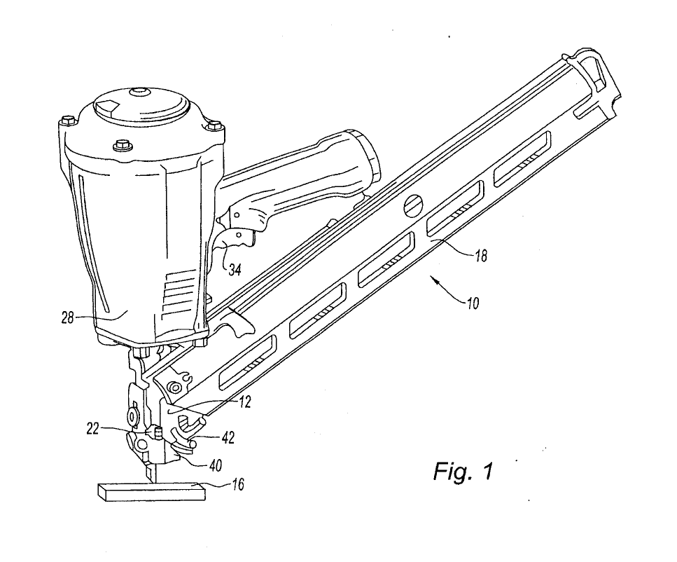

FIG. 1 is a perspective view of a fastening tool of the invention;

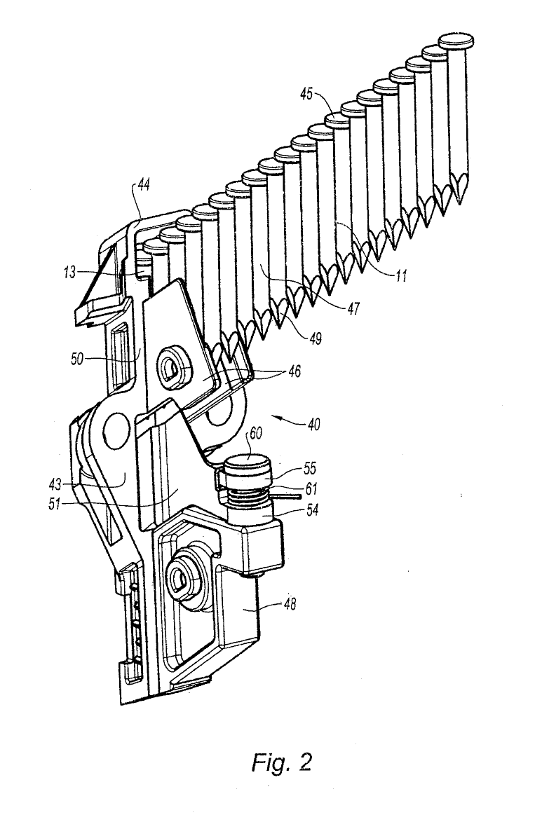

FIG. 2 is a back perspective view of the shear unit of the tool of FIG. 1;

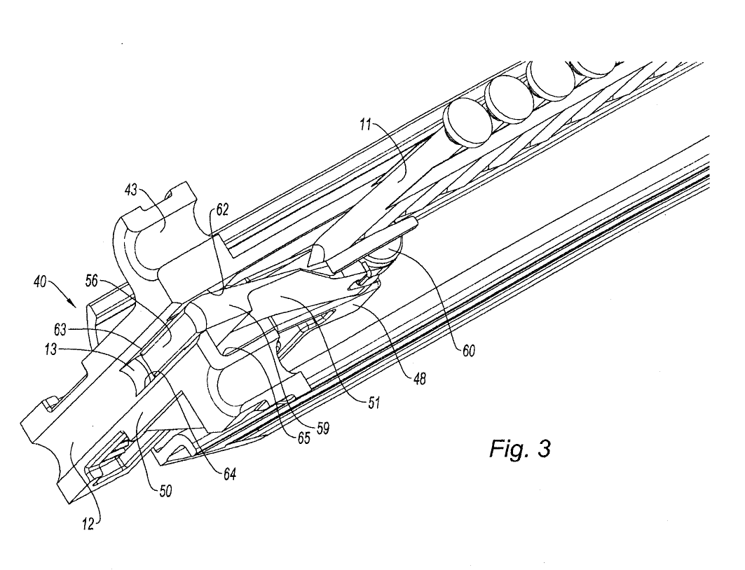

FIG. 3 is a top perspective view of the shear unit of FIG. 2, partly sectioned;

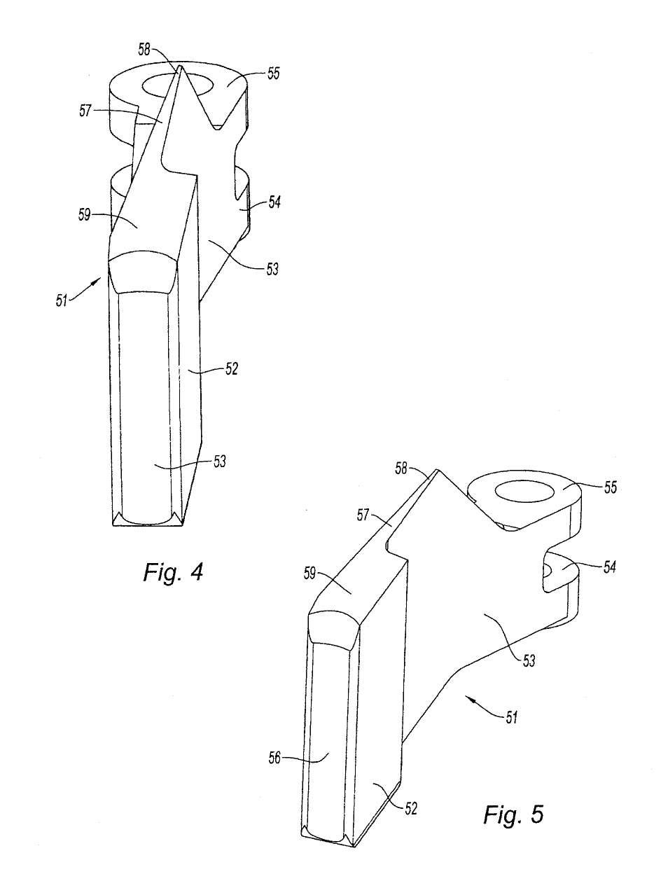

FIG. 4 is a front perspective view of the length adjustment flap of the tool shear unit;

FIG. 5 is a side perspective view of the length adjustment flap of the tool shear unit;

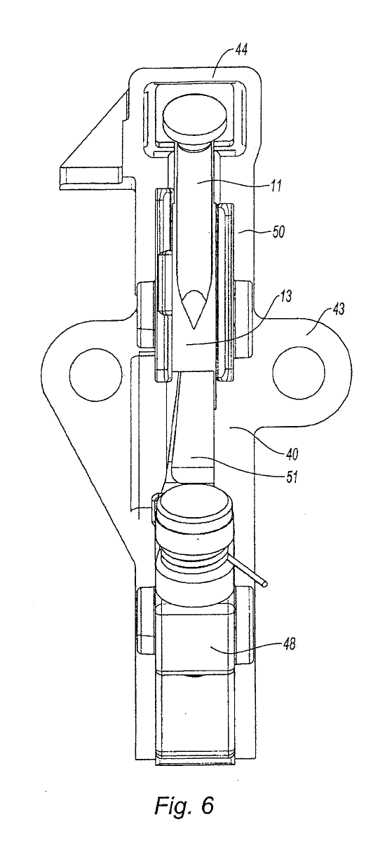

FIG. 6 is a back view of the tool shear unit, the adjustment panel being in a plugging position; and

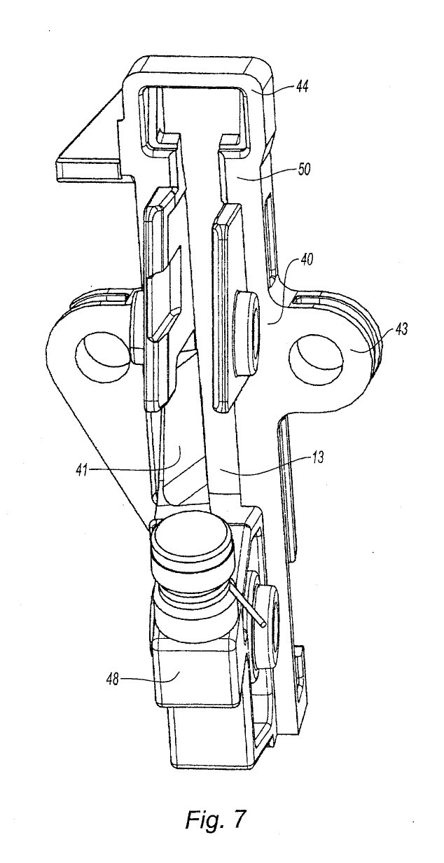

FIG. 7 is a back perspective view of the tool shear unit, the adjustment flap in an opening position.

The fastening tool 10 of FIG. 1 is intended to drive fastening elements of different lengths. In that case, it is a nail driver. The tool comprises a housing 28 to which an assembly 12 of a tip-guide, or nose 22, and a shear unit 40 is fastened. To the shear unit 40 can be fastened, like on FIG. 1, a charger 18 comprising here a strip of nails. The tool is thus used here for driving nails into a receiving material 16, for instance in a panel nailing process.

The fastening elements 11 are introduced from the charger 18 (FIG. 3) into a bore 12 formed by the tip-guide 22 and the shear unit 40, through a passing window 13 provided in the shear unit 40 (FIGS. 6, 7). The bore 12 extends the bore of the tool barrel in the housing 28, in which a feeder can be driven upon a shot caused by the tool being put against the receiving material 16 and the action of the trigger 34, to propel a nail 11 into the material 16. The passing window 13, which is an opening formed in the bore 12, has an axial length (that is in the direction of the tool barrel and tip-guide axis) allowing for the longest nails to go through.

The shear unit 40 is a part completing the tip-guide 22 for forming the bore 12; the advantage of those two parts that are assembled is to allow for them to be disassembled when needed, when a fastening element 11 has been put askew and causes a tool trouble. The shear unit 40 thus constitutes the outlet of the charger 18 and takes generally the form of a frame 50, providing the passing window 13, with side hearings 43 for fastening to the tip-guide, an upper gantry-shaped part 44 for the passage of the fastening elements, here, as nails 11 are concerned, for the passage of their heads 45 and adjacent parts, a pair of small rear side plates 46 to guide the nail rods 47, and a rear bracket 48 supporting a flap 51 for adjusting the length of the passing window 13. In case of long nails, the small guiding plates 46 really surround the nail rods 47. But in case of small nails, the small plates 46 only surround the nail tips 49 and the adjacent rod parts.

Referring to FIGS. 4, 5, the adjustment flap 51 comprises, from front to back, but integrally formed, a door portion 52 of a general parallelepiped shape, a linking veil 53 and, here, two bottom and top pivoting flange rings 54, 55, with an axis substantially parallel to the axis of the bore 12. The front part 56 of the door part 52 is chamfered. The top part has a generally rectangular surface 59 extending in the veil part 53 according to a triangle shape 57 up to a tapered zone 58, from which the veil part 53 returns down to the plane of the top flange ring 55. The panel 51 is mounted on the bracket 48 of the sear unit through a shaft 60, extending substantially parallel to the axis of the bore 12, which shaft is driven through the two flange rings 54, 55 of the flap and introduced inside the bracket 48, with a coil spring 61, fastened to the shaft 60 and one of the flange rings 54, 55, to return back the flap 51 in a plugging position as it will be developed now. Of course, a real parallelism of the bore axis, of the axis of the flange rings and of the flap shaft, can be envisioned. The adjustment flap can only comprise one flange ring if a compression spring is used on the linking veil 53.

The flap 51 can pivot about the shaft 60, from a plugging position for the passing window 13 (FIG. 6) to an opening position for the passing window 13 (FIG. 7). In the plugging position, the flap 51, with its top surface 59, provides a guiding surface (but at first sight, the nails are not in contact with this surface), for the short nails, through their tips 49. In other words, the passing window 13 is plugged on the flap 51 height, but the outlet of the charger 18 is also plugged at the flap top face, thus forming a bottom for the passageway of short nails. Furthermore, it should be noticed that designating the top surface 59 of the flap 51 as guiding surface or sliding ramp is somewhat exaggerated. In fact, the short nail tips 49 are, theoretically, not in contact with this surface. They can only be so. That is to better qualify this flap top surface that it will go on being designated as such. Therefore and beyond the fact that due to the flap 51, the short nails cannot rock, any jam is avoided. In a plugging position, the flap 51 partially plugs the passing window 13, to let the part of the window, from the top of the gantry 44, be free to short nails. The spring 61 returns the flap 51 in a partial plugging position for passing and guiding the short nails. In the case where the charger 18 would comprise long nails, the mechanism for pushing the nail strip towards the bore 12 pushes the nails so that they rotate the flap 51 and thus open the passage through the window 13. When using long nails, the nails maintain the flap 51 pivoted against the action of the spring 61. To allow for the flap 51 to pivot (FIG. 3), the frame 50 of the shear unit 40, in the zone adjacent to the passing window 13, comprises a first plan wall 62 in the plan of the edges 63 of the window 13. In contrast, the frame 50, on the opposed side, that is on the side for the other edge 64 of the window 13, is adapted to present a recess 65 for receiving the flap 51 in a pivoted position. On FIG. 3, the flap is in a plugging position, the recess 65 being free.

The adjustment flap has been described with two flange rings, with a shaft being driven therethrough, for pivoting the flap on the bracket. A shaft integral with the flap being mounted on the bracket bearings could be envisioned. A spring blade causing the rotation of the flap with no rotation axis could also be imagined instead of the flange rings, the shaft and the spring.

1. A fastening tool for driving fastening elements of different lengths, comprising an assembly of a tip-guide and a shear unit, to which can be fastened a charger comprising fastening elements, the fastening elements being introduced from the charger inside the bore of the tip-guide through a passing window provided inside the shear unit, the tool comprising a pivoting device for adjusting the effective length of the passing window to the length of the fastening elements to be driven, and which is submitted to return means in a partial plugging position of the window for the shortest elements, characterised in that the adjustment device comprises a flap pivotally mounted about an axis substantially parallel to the bore of the tip-guide and is adapted to provide a guiding surface for the shortest fastening elements before they enter into the partially plugged passing window.

2. A fastening tool according to claim 1, wherein the adjustment flap is mounted on the bracket mounted at the rear of the frame shaped shear unit.

3. A fastening tool according to claim 1, wherein the shear unit comprises a pair of small rear side plates for guiding fastening elements.

4. A fastening tool according to any of claim 1, wherein the adjustment flap comprises a door part, a linking veil and two pivoting flange rings.

5. A fastening tool according to claim 4, wherein the top part of the flap presents a guiding surface.

6. A fastening tool according to any of claim 1, wherein the shear unit is adapted to present a recess for receiving the adjustment flap.
